(19) United States
(12) Patent Application Publication
(10) Pub. No.: US 2026/0054321 A1
(43) Pub. Date: Feb. 26, 2026

(54) METHOD FOR FABRICATING ELECTRICITY STORAGE DEVICE AND ELECTRICITY STORAGE DEVICE

(71) Applicant: Prime Planet Energy & Solutions, Inc., Tokyo (JP)

(72) Inventor: Kazuki TAMURA, Takasago-shi (JP)

(21) Appl. No.: 19/296,934

(22) Filed: Aug. 12, 2025

(30) Foreign Application Priority Data
Aug. 26, 2024 (JP) 2024-144106

(51) Int. Cl. B23K 26/26; H01M 50/169

(52) U.S. Cl. CPC B23K 26/26; H01M 50/169

(57) ABSTRACT

A method for fabricating an electricity storage device includes a case preparing step, a sealing plate preparing step, an assembly step, and a main welding step. In the case preparing step, a square case including an opening is prepared. In the sealing plate preparing step, a sealing plate to be attached to the opening along an edge of the opening is prepared. In the assembly step, the sealing plate is attached to the opening of the case. In the main welding step, the case and the sealing plate are laser welded over an entire circumference of a periphery of the sealing plate. In the main welding step, a start point of laser welding is set inward of the periphery of the sealing plate.

### CROSS REFERENCE TO RELATED APPLICATIONS

This application claims the benefit of priority to Japanese Patent Application No. 2024-144106 filed on Aug. 26, 2024. The entire contents of this application are hereby incorporated herein by reference.

### BACKGROUND

The present disclosure relates to a method for fabricating an electricity storage device and an electricity storage device.

JP2018-202478A discloses a laser welding device including a means for dividing one laser beam into two laser beams, and a means for moving the two light beams in parallel along a joining interface between two members. In this laser welding device, the two laser beams are symmetrically arranged at positions equal from the joining interface so that the two laser beams do not enter the joining interface. JP2018-202478A shows that the use of this laser welding device achieves high-quality welding in welding the two members. For example, JP2018-202478A describes that the use of the laser welding device suppresses occurrence of spatters in fabricating a lithium battery including a container having an opening and a lid attached to the opening and welded to the container.

### SUMMARY

An inventor of the present disclosure intends to increase joint strength between a case and a sealing plate.

A method for fabricating an electricity storage device disclosed here includes: preparing a square case including an opening; preparing a sealing plate to be attached to the opening along an edge of the opening; preparing assembly of attaching the sealing plate to the opening of the case; and performing main welding of laser welding the case and the sealing plate over an entire circumference of a periphery of the sealing plate. In the main welding, a start point of laser welding is set inward of the periphery of the sealing plate. This fabrication method can enhance the joint strength between the case and the sealing plate.

### BRIEF DESCRIPTION OF THE DRAWINGS

FIG. 1 is a perspective view schematically illustrating an electricity storage device.

FIG. 2 is a disassembled perspective view of the electricity storage device.

FIG. 3 is a flowchart showing an example of a method for fabricating an electricity storage device.

FIG. 4 is an illustration for describing a temporary welding step.

FIG. 5 is an illustration for describing a main welding step.

FIG. 6 schematically illustrates a vicinity of a start point of laser welding in the main welding step.

FIG. 7 is a plan view schematically illustrating a case and a sealing plate after the main welding step is finished.

FIG. 8 is an enlarged view of a vicinity of an inner projecting portion in FIG. 7.

FIG. 9 schematically illustrates a vicinity of a start point of laser welding in a main welding step according to another embodiment.

### DETAILED DESCRIPTION

An embodiment of the technique disclosed here will be described hereinafter with reference to the drawings. The embodiment described herein is, of course, not intended to particularly limit the present disclosure. Each drawing is a schematic view and does not necessarily reflect an actual product. Members and parts having the same functions are denoted by the same reference numerals as appropriate, and description for the same members and parts will not be repeated as appropriate. Characters X, Y, and Z in the drawings represent front-rear directions, left-right directions, and top-bottom directions, respectively. The Y directions are orthogonal to the X directions. The Z directions are orthogonal to the X directions and the Y directions. Characters F, Rr, L, R, U, and D in the drawings represent front, rear, left, right, up, and down, respectively. It should be noted that these directions are defined merely for convenience of description, and do not limit the state of installation of the electricity storage device. An expression such as “X to Y” indicating a numerical range means “X or more and Y or less” unless otherwise specified.

An “electricity storage device” herein refers to a device capable of being charged and discharged. The electricity storage device includes batteries such as a lithium polymer battery and a nickel hydrogen battery as well as batteries generally called a lithium ion battery and a lithium secondary battery. The secondary battery generally refers to a battery capable of being repeatedly charged and discharged with movement of charge carriers between positive and negative electrodes. The electricity storage device may use an electrolyte or may use a solid electrolyte. For example, the secondary battery may be a secondary battery using a so-called liquid-based electrolyte, or a so-called all-solid-state battery using a solid electrolyte. The electricity storage device includes capacitors such as an electric double layer capacitor or a lithium ion capacitor.

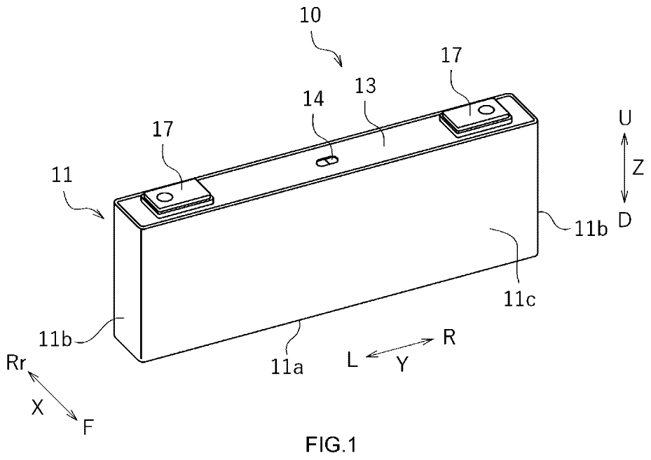

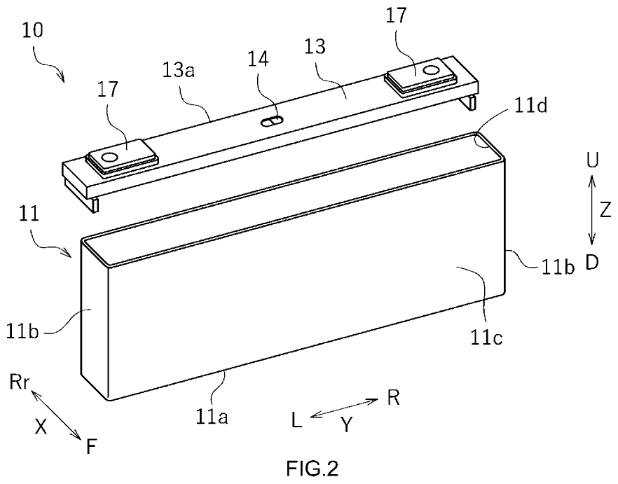

FIG. 1 is a perspective view schematically illustrating an electricity storage device 10. FIG. 2 is a disassembled perspective view of the electricity storage device 10. As illustrated in FIGS. 1 and 2, the electricity storage device 10 includes a case 11 and a sealing plate 13.

The case 11 is a square case of a substantially rectangular parallelepiped shape. The case 11 has short sides extending in the X directions and long sides extending in the Y directions when seen from above. The case 11 includes a bottom surface 11a, a pair of narrow surfaces 11b, and a pair of wide surfaces 11c. The bottom surface 11a has a rectangular shape with short sides and long sides. The narrow surfaces 11b serving as a pair face each other in the Y directions. The pair of narrow surfaces 11b extends upward from both ends of the bottom surface 11a in the Y directions. The wide surfaces 11c serving as a pair face each other in the X directions. The pair of wide surfaces 11c extends upward from both ends of the bottom surface 11a in the X directions. The pair of narrow surfaces 11b and the pair of wide surfaces 11c constitute side surfaces of the case 11. As illustrated in FIG. 2, the case 11 has a rectangular opening 11d in an upper portion thereof. From the viewpoint of obtaining light weight and required rigidity, the case 11 is made of, for example, aluminum or an aluminum alloy mainly containing aluminum. Although not shown, the case 11 accommodates an electrode body including a positive electrode and a negative electrode. Although not shown, in a case where the electricity storage device 10 is a liquid battery, the case 11 also contains an electrolyte.

The sealing plate 13 is a member that closes the opening 11d of the case 11. The sealing plate 13 is attached to the opening 11d of the case 11 along the edge of the opening 11d. In the state illustrated in FIG. 1, the sealing plate 13 is a rectangular flat plate. The sealing plate 13 may be made of the same material as the case 11. The sealing plate 13 may be made of, for example, aluminum or an aluminum alloy mainly containing aluminum.

The sealing plate 13 has a gas release valve 14 for emitting gas inside the case 11. The gas release valve 14 is located at the center of the sealing plate 13 in the Y directions. The gas release valve 14 is a thin portion designed to break when the internal pressure of the case 11 rises to a predetermined value or more. When the internal pressure of the case 11 exceeds the predetermined value, the gas release valve 14 breaks, causing the gas inside the case 11 to be emitted to the outside of the case 11.

A pair of electrode terminals 17 is located at both ends of the sealing plate 13 in the Y directions. The method for attaching the electrode terminals 17 to the sealing plate 13 is not particularly limited. For example, the electrode terminals 17 may be attached to the sealing plate 13 using a crimping process. The electrode terminals 17 may be integrated with the sealing plate 13. The electrode terminals 17 are electrically connected to the electrode body accommodated inside the case 11. One of the pair of electrode terminals 17 is a positive electrode terminal electrically connected to a positive electrode. The other of the pair of electrode terminals 17 is a negative terminal electrically connected to a negative electrode.

In the electricity storage device 10 as illustrated in FIG. 1, in a state where the electrode body is housed inside the case 11, the case 11 and the sealing plate 13 are laser welded over the entire circumference of a periphery 13a of the sealing plate 13. Accordingly, the case 11 and the sealing plate 13 are joined so that the inside of the case 11 is sealed. For example, in a case where the electricity storage device 10 is a liquid battery, the sealing of the inside of the case 11 prevents the electrolyte from leaking out of the case 11.

In the electricity storage device 10 as described above, the case 11 expands in some cases due to factors such as generation of gas accompanying charging and discharging. When the case 11 expands, a load is applied to a joint between the case 11 and the sealing plate 13. Therefore, a joint strength greater than or equal to a predetermined value is required at the joint between the case 11 and the sealing plate 13. However, the inventor of the present disclosure found that the joint between case 11 and the sealing plate 13 might fail to have a predetermined joint strength especially near a start point of laser welding. The inventor of the present disclosure has conducted an intensive investigation regarding this case and has considered the case as follows.

Laser welding is a technique for joining two members as welding targets by applying laser light to a vicinity of the boundary between the two members to melt the two members. The joint strength of the two members depends on the welding depth. The welding depth is a depth at which melting occurs in members as welding targets. When the welding depth is deep, the joint strength is high, whereas when the welding depth is shallow, the joint strength is low. Thus, to increase the joint strength at the joint between case 11 and the sealing plate 13, laser welding needs to be performed such that the welding depth is sufficiently deep. However, it is considered that immediately after the start of laser welding, the temperatures of the case 11 and the sealing plate 13 rise insufficiently so that the case 11 and the sealing plate 13 may melt inadequately. Consequently, the welding depth might be shallow near the start point of laser welding.

Additionally, due to factors such as dimensional tolerance in manufacturing, a positional relationship of the case 11 and the sealing plate 13 with respect to the laser used for laser welding can deviate relatively from an ideal positional relationship. The ideal positional relationship herein means a positional relationship of the case 11 and the sealing plate 13 with respect to the laser that is optimal for performing laser welding properly. Additionally, due to factors such as manufacturing dimensional tolerance, a gap can occur between the case 11 and the sealing plate 13 when the sealing plate 13 is attached to the case 11. The inventor of the present disclosure found that the joint strength is likely to be low near the start point of laser welding in a case where laser is shifted toward the case 11 relative to the ideal positional relationship and a gap occurs between the case 11 and the sealing plate 13. The inventor of the present disclosure also found that when laser is positioned with respect to the case 11 and the sealing plate 13 as described above, the sealing plate 13 is particularly unlikely to be melted immediately after start of laser welding, and thus, the welding depth tends to be shallow near the start point of laser welding.

Further, the inventor of the present disclosure found that in fabricating a relatively large electricity storage device 10 in which the width of the case 11 is 30 cm or more, the welding depth tends to be especially shallow near the start point of laser welding. The inventor of the present disclosure considers this case as follows. When fabricating a relatively large electricity storage device 10, the dimensional tolerance of the case 11 and the sealing plate 13 tends to be larger, which makes it likely for a relatively large gap to occur between the case 11 and the sealing plate 13, and laser is likely to deviate relatively significantly toward the case 11 from the ideal positional relationship. According to the finding of the inventor of the present disclosure, in a case where the width of the case 11 is about 30 cm, for example, a gap of about 0.2 mm can occur between the case 11 and the sealing plate 13. The inventor of the present disclosure also found that in the case where the width of the case 11 is about 30 cm, the laser can deviate toward the case 11 by about 0.2 mm from the ideal positional relationship. The width of the case 11 herein refers to the length of the case 11 in the Y directions.

Based on the above, the inventor of the present disclosure intends to achieve welding with a sufficiently deep welding depth over the entire circumference of the periphery 13a of the sealing plate 13, even when the laser is positioned with respect to the case 11 and the sealing plate 13 as described above. More specifically, the inventor of the present disclosure intends to sufficiently melt the sealing plate 13 near the start point of laser welding at the periphery 13a of the sealing plate 13, even when the laser is positioned with respect to the case 11 and the sealing plate 13 as described above.

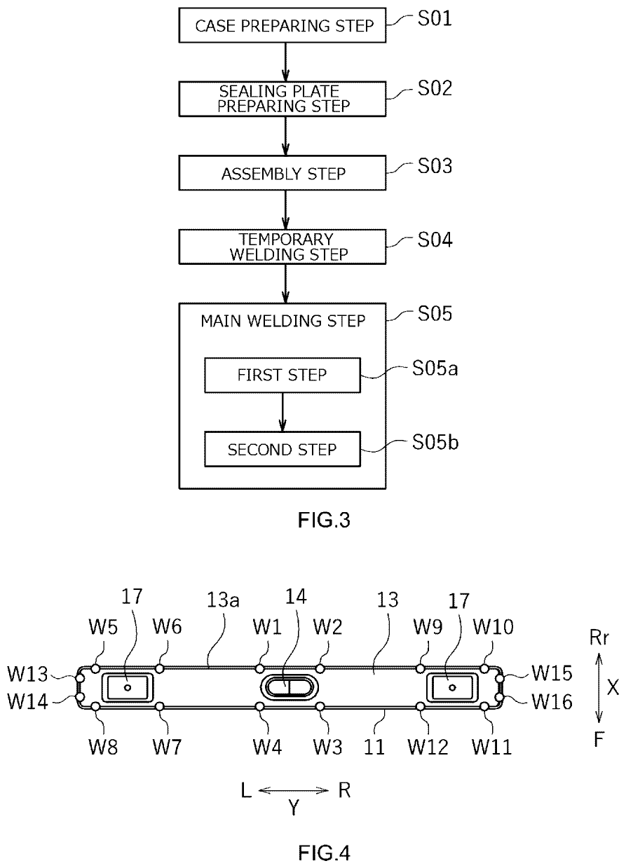

FIG. 3 is a flowchart showing an example of a method for fabricating the electricity storage device 10. The method for fabricating the electricity storage device 10 includes a case preparing step S01, a sealing plate preparing step S02, an assembly step S03, a temporary welding step S04, and a main welding step S05. The method for fabricating the electricity storage device 10 may not include the temporary welding step S04.

In the case preparing step S01, a square case 11 including the opening 11d is prepared. In the case preparing step S01, the method for preparing the case 11 is not particularly limited. The case 11 is prepared through molding by bending a single rectangular flat plate, for example. The case 11 prepared in the case preparing step S01 may have a width of 30 cm or more. By preparing such a relatively large case, a relatively large electrode body can be housed in the case 11, and thus, a high-capacity electricity storage device can be obtained.

In the sealing plate preparing step S02, a sealing plate 13 to be attached to an opening 11d of the case 11 along the edge of the opening 11d is prepared. In the sealing plate preparing step S02, the sealing plate 13 with electrode terminals 17 is prepared. In the sealing plate preparing step S02, the method for preparing the sealing plate 13 is not particularly limited. The sealing plate 13 is prepared by, for example, performing machining such as punching on a single rectangular flat plate and then attaching the electrode terminals 17 and other members to the plate. The sealing plate 13 may be prepared by integrally molding together with the electrode terminals 17 and other members. The sealing plate preparing step S02 may be performed before or after the case preparing step S01. The sealing plate preparing step S02 and the case preparing step S01 may be performed at the same time.

In the assembly step S03, an electrode body is inserted into the case 11. Thereafter, the sealing plate 13 is attached to the opening 11d of the case 11.

FIG. 4 is an illustration for describing the temporary welding step S04. FIG. 4 illustrates the case 11 and the sealing plate 13 when seen from above. In the temporary welding step S04, the case 11 and the sealing plate 13 are temporarily welded with the sealing plate 13 attached to the opening 11d. This temporary welding is performed in order to position the sealing plate 13 with respect to the case 11. In the temporary welding step S04, the case 11 and the sealing plate 13 are intermittently welded. In the state illustrated in FIG. 4, predetermined 16 portions of the boundary between the case 11 and the sealing plate 13 are temporarily welded. Characters W1 to W16 in FIG. 4 represent positions where temporary welding is performed. In the state illustrated in FIG. 4, as indicated by characters W1 to W4, predetermined portions near the gas release valve 14 in the boundary between the case 11 and the sealing plate 13 are temporarily welded. In the state illustrated in FIG. 4, as indicated by characters W5 to W12, predetermined portions near the electrode terminals 17 in the boundary between the case 11 and the sealing plate 13 are temporarily welded. The positions and number of portions where temporary welding is performed are not limited only to the state illustrated in FIG. 4, and can be changed as appropriate depending on dimensions of the case 11 and dimensions of the sealing plate 13. The welding device used in the temporary welding step S04 may be the same as, or different from, the device used in the main welding step S05. In the temporary welding step S04, various welding devices known to date may be used.

FIG. 5 is an illustration for describing the main welding step S05. FIG. 5 illustrates the case 11 and the sealing plate 13 when seen from above. The arrow indicated by character WT in FIG. 5 represents a welding path in the main welding step S05. A point indicated by character P1 in FIG. 5 is a start point of main welding. In the following description, the start point of main welding will also be simply referred to as a start point P1. In the main welding step S05, the case 11 and the sealing plate 13 are main-welded. The main welding is performed to seal the opening 11d. In the main welding step S05, the case 11 and the sealing plate 13 are laser welded over the entire circumference of the periphery 13a of the sealing plate 13. As illustrated in FIG. 3, the main welding step S05 includes a first step S05a and a second step S05b. In the main welding step S05, various laser welding devices known to date may be used.

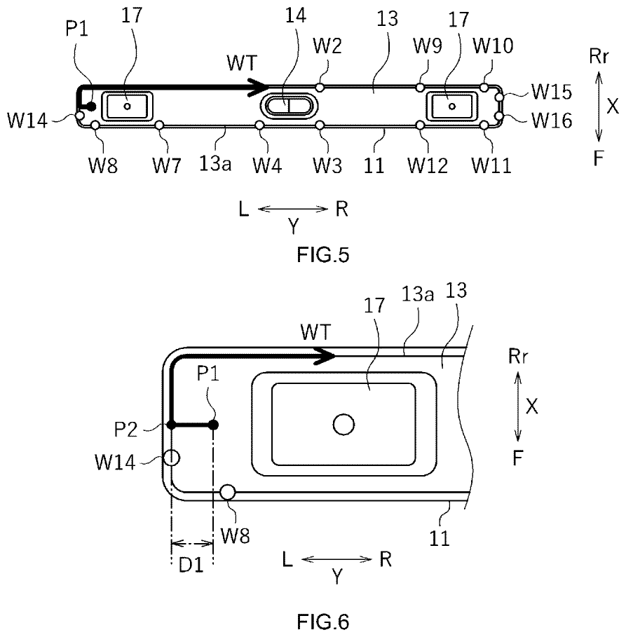

FIG. 6 schematically illustrates a vicinity of the start point P1. Character P2 in FIG. 6 indicates an end point of the first step S05a. In the following description, the end point P2 of the first step S05a will also be simply referred to as an end point P2. Character D1 in FIG. 6 indicates a distance between the start point P1 and the end point P2. In the main welding step S05, the start point P1 of laser welding is set inward of the periphery 13a of the sealing plate 13. In the state illustrated in FIG. 6, the start point P1 is set at the left of the left electrode terminal 17. In the state illustrated in FIG. 6, the start point P1 is set at the center of the sealing plate 13 in the X directions. The end point P2 is set on the periphery 13a of the sealing plate 13. The distance D1 between the start point P1 and the end point P2 corresponds to a distance in which laser welding is performed in the first step S05a. The distance D1 between the start point P1 and the end point P2 may be about 0.5 mm to about 1.5 mm, for example. It should be noted that the distance D1 between the start point P1 and the end point P2 may be changed as appropriate depending on conditions such as an output value of the laser used for laser welding, a material for the sealing plate 13, and a welding speed.

In the first step S05a, laser welding is performed from the start point P1 toward the periphery 13a of the sealing plate 13. In the state illustrated in FIG. 6, in the first step S05a, laser welding is performed leftward from the start point P1 to the end point P2. In the state illustrated in FIG. 6, in the first step S05a, laser welding is performed such that the welding path WT perpendicular to the periphery 13a of the sealing plate 13. In the first step S05a, an output of the laser used for laser welding is controlled such that the output of the laser increases as a welding position by laser welding approaches the periphery 13a of the sealing plate 13 from the start point P1. In the first step S05a, the output of the laser is controlled such that when the welding position reaches the end point P2, the output of the laser is a predetermined value.

The second step S05b is performed consecutively after the first step S05a. In the second step S05b, after the first step S05a has been finished, the case 11 and the sealing plate 13 are laser welded over the entire circumference of the periphery 13a of the sealing plate 13 along the periphery 13a of the sealing plate 13. In the second step S05b, laser welding starts from the end point P2 of the first step S05a. In the second step S05b, the output of the laser is controlled such that the output of the laser is maintained at the predetermined value. In the state illustrated in FIG. 6, in the second step S05b, laser welding is performed clockwise from the end point P2 in the first step S05a. In the second step S05b, laser welding may be performed counterclockwise from the end point P2 of the first step S05a. In the second step S05b, laser welding starts from the end point P2 of the first step S05a, is performed around the periphery 13a of the sealing plate 13, and reaches the end point P2 of the first step S05a again, and then, is finished. The welding step S05 is completed by the completion of the second step S05b. When the main welding step S05 is finished, the case 11 and the sealing plate 13 are welded without a gap, and the inside of the case 11 is sealed.

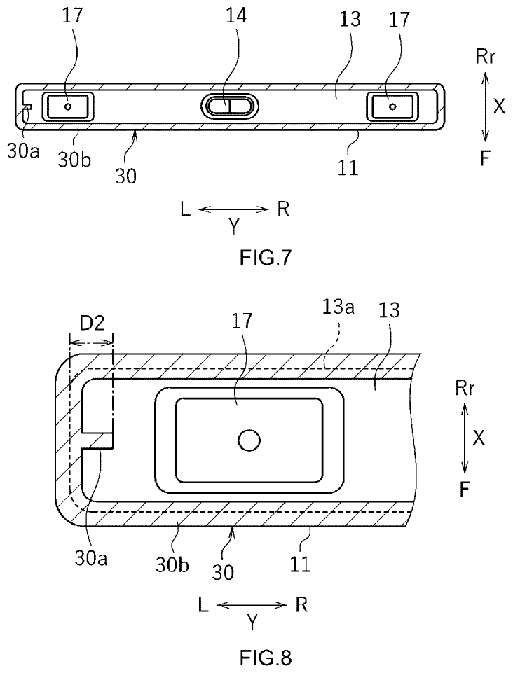

FIG. 7 is a plan view schematically illustrating the case 11 and the sealing plate 13 after the main welding step S05 is finished. In FIG. 7, the hatched portion indicates a welded mark 30 formed by laser welding performed in the main welding step S05. FIG. 7 shows the welded mark 30 in an enlarged manner. The welded mark 30 is formed over the entire circumference of the periphery 13a of the sealing plate 13. The welded mark 30 includes an inner projecting portion 30a and a body portion 30b. As illustrated in FIG. 7, the body portion 30b has an annular shape along the entire circumference of the periphery 13a of the sealing plate 13. The body portion 30b is a welded mark formed by laser welding performed in the second step S05b. The inner projecting portion 30a projects from the body portion 30b. The inner projecting portion 30a projects inward relative to the periphery 13a of the sealing plate 13. The inner projecting portion 30a is a welded mark formed by laser welding performed in the first step S05a.

FIG. 8 is an enlarged view of a vicinity of the inner projecting portion 30a in FIG. 7. The broken line in FIG. 8 indicates the periphery 13a of the sealing plate 13. Character D2 in FIG. 8 indicates a distance from the periphery 13a of the sealing plate 13 to an end of the inner projecting portion 30a. The distance D2 from the periphery 13a of the sealing plate 13 to the end of the inner projecting portion 30a is a length of the welded mark formed by laser welding in the first step S05a.

Near the start point P1 shown in FIG. 6, the temperature of the sealing plate 13 rises insufficiently so that the sealing plate 13 might not melt, and accordingly, no welded marks might be formed. In such a case, the distance D2 from the periphery 13a of the sealing plate 13 to the end of the inner projecting portion 30a is shorter than the distance D1 between the start point P1 and the end point P2. On the other hand, when the temperature at the start point P1 rises sufficiently, the sealing plate 13 melts at the start point P1, and thus, a welded mark is also formed at the start point P1. Further, such a case, a portion of the sealing plate 13 inward of the start point P1 is also melted to form a welded mark in some case. In view of this, the distance D2 from the periphery 13a of the sealing plate 13 to the end of the inner projecting portion 30a can be greater than or equal to the distance D1 between the start point P1 and the end point P2. Thus, the distance D2 from the periphery 13a of the sealing plate 13 to the end of the inner projecting portion 30a can be shorter than, equal to, or longer than the distance D1 between the start point P1 and the end point P2. That is, a relationship between the length of the welded mark formed by laser welding in the first step S05a and the distance over which laser welding is performed in the first step S05a varies depending on conditions such as the output value of the laser, the material for the sealing plate 13, and the welding speed. For example, in a case where the distance D1 between the start point P1 and the end point P2 is about 1 mm, the distance D2 from the periphery 13a of the sealing plate 13 to the end of the inner projecting portion 30a can be about 0.5 mm to about 2 mm.

When the main welding step S05 is finished, an injection step of injecting an electrolyte into the case 11, an aging step of charging the electricity storage device 10 and leaving the electricity storage device 10 for a predetermined time, an inspection step of inspecting an internal short circuit or the like in the electricity storage device 10, and other steps are performed as appropriate, and the electricity storage device 10 is fabricated.

The method for fabricating the electricity storage device 10 according to this embodiment includes the main welding step S05 of laser welding the case 11 and the sealing plate 13 over the entire circumference of the periphery 13a of the sealing plate 13. The main welding step S05 includes the first step S05a and the second step S05b. In the main welding step S05, the start point P1 of laser welding is set inward of the periphery 13a of the sealing plate 13. In the first step S05a, laser welding is performed from the start point P1 toward the end point P2 set on the periphery 13a of the sealing plate 13. In the second step S05b, the case 11 and the sealing plate 13 are laser welded from the end point P2 over the entire circumference of the periphery 13a of the sealing plate 13 along the periphery 13a of the sealing plate 13.

In the fabrication method according to this embodiment, in the first step S05a, laser light is applied to a portion inward of the periphery 13a of the sealing plate 13, and thus, the temperature of the sealing plate 13 is likely to rise. Thus, when the welding position reaches the end point P2 that is an end position of the first step S05a, the sealing plate 13 has been sufficiently melted at the end point P2. Further, the second step S05b is performed consecutively after completion of the first step S05a. Accordingly, the second step S05b starts in a state where the temperature of the sealing plate 13 has risen sufficiently. Consequently, in the second step S05b, it is possible to perform welding with a sufficiently deep welding depth over the entire circumference of the periphery 13a of the sealing plate 13. In particular, at the end point P2 that is a start position of the second step S05b, it is also possible to perform welding with a sufficiently deep welding depth. This can enhance the joint strength between the case 11 and the sealing plate 13.

In this embodiment, in the first step S05a, an output of the laser used for laser welding is increased as the welding position by laser welding approaches the periphery 13a of the sealing plate 13 from the start point P1. This can suppress an abrupt rise of the temperature of the sealing plate 13, and thus, can reduce occurrence of spatters.

As described above, according to the finding of the inventor of the present disclosure, in fabricating a relatively large electricity storage device 10 in which the case 11 has a width of 30 cm or more, a relatively large gap is likely to occur between the case 11 and the sealing plate 13, and the laser is likely to deviate relatively significantly toward the case 11 from an ideal positional relationship. Thus, in fabricating the relatively large electricity storage device 10, the welding depth tends to be shallow at the start point of laser welding. On the other hand, the relatively large electricity storage device 10 is required to have a particularly high joint strength. Thus, in fabricating the relatively large electricity storage device 10, even when the laser is positioned with respect to the case 11 and the sealing plate 13 as described above, main welding needs to be performed to have a sufficiently deep welding depth over the entire circumference of the periphery 13a of the sealing plate 13. With the fabrication method according to this embodiment, welding with a sufficiently deep welding depth can be performed over the entire circumference of the periphery 13a of the sealing plate 13 without omission. Accordingly, in fabricating a relatively large battery, the fabrication method according to this embodiment can be particularly effectively employed.

One embodiment of the technique proposed here has been described above. The embodiment described above, however, is merely an example, and the present disclosure can be carried out in other modes.

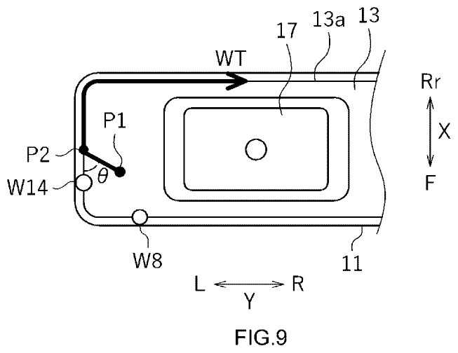

FIG. 9 schematically illustrates a vicinity of a start point P1 of laser welding in a main welding step S05 according to another embodiment. In the state illustrated in FIG. 9, in the first step S05a, laser welding is performed obliquely with respect to a periphery 13a of a sealing plate 13. Here, from the viewpoint of sufficiently increasing the temperature of the sealing plate 13, an angle formed by a welding path WT and the periphery 13a of the sealing plate 13 in the first step S05a is preferably about 30° to about 150°, more preferably about 45° to about 135°.

In the state illustrated in FIG. 6, the start point P1 is set at the left of the left electrode terminal 17. However, the position of the start point P1 is not limited only to the state illustrated in FIG. 6. For example, the start point P1 may be set at the right of the right electrode terminal 17. In this case, in the first step S05a, laser welding may be performed rightward from the start point P1 to the periphery 13a of the sealing plate 13. The start point P1 may be set between the gas release valve 14 and the left electrode terminal 17. In this case, in the first step S05a, laser welding may be performed forward or rearward from the start point P1 to the periphery 13a of the sealing plate 13. Similarly, the start point P1 may be set between the gas release valve 14 and the right electrode terminal 17.

The method for fabricating the electricity storage device 10 may include steps other than the steps described above. For example, the method for fabricating the electricity storage device 10 may include a clamping step of pressing the case 11 against the sealing plate 13 before the main welding step S05. This can suppress occurrence of laser leakage. The laser leakage refers to a phenomenon in which laser light passes through a gap between the case 11 and the sealing plate 13 and enters the inside of the case 11. Similarly, the method for fabricating the electricity storage device 10 may also include a clamping step before the temporary welding step S04.

The technique disclosed here has been described in details. Unless otherwise specified, the embodiment and other examples mentioned herein do not limit the present disclosure. The technique disclosed here can be modified in various ways, and the constituent elements and the processes described here can be appropriately omitted or appropriately combined unless no particular problems arise. The specification includes the disclosures described in the following items.

### Item 1

A method for fabricating an electricity storage device includes:
preparing a square case including an opening;
preparing a sealing plate to be attached to the opening along an edge of the opening;
preparing assembly of attaching the sealing plate to the opening of the case; and
performing main welding of laser welding the case and the sealing plate over an entire circumference of a periphery of the sealing plate, wherein
in the main welding, a start point of laser welding is set inward of the periphery of the sealing plate.

### Item 2

In the fabrication method of Item 1, the main welding includes
a first step of performing laser welding from the start point toward the periphery of the sealing plate, and
a second step of laser welding the case and the sealing plate over an entire circumference of the periphery of the sealing plate along the periphery of the sealing plate, after the first step has been finished.

### Item 3

In the fabrication method of Item 1 or 2, in the main welding, an output of a laser used for laser welding is increased as a welding position by laser welding approaches the periphery of the sealing plate from the start point.

### Item 4

In the fabrication method of any one of Items 1 to 3, the case prepared in the preparing the case has a width of 30 cm or more.

### Item 5

An electricity storage device obtained by the method of any one of Items 1 to 4, a welded mark is formed over an entire circumference of the periphery of the sealing plate, and the welded mark includes an inner projecting portion projecting inward relative to the periphery of the sealing plate.

What is claimed is:

1. A method for fabricating an electricity storage device, the method comprising:
preparing a square case including an opening;
preparing a sealing plate to be attached to the opening along an edge of the opening;
preparing assembly of attaching the sealing plate to the opening of the case; and
performing main welding of laser welding the case and the sealing plate over an entire circumference of a periphery of the sealing plate, wherein
in the main welding, a start point of laser welding is set inward of the periphery of the sealing plate.

2. The method according to claim 1, wherein
the main welding includes
a first step of performing laser welding from the start point toward the periphery of the sealing plate, and
a second step of laser welding the case and the sealing plate over an entire circumference of the periphery of the sealing plate along the periphery of the sealing plate, after the first step has been finished.

3. The method according to claim 1, wherein
in the main welding, an output of a laser used for laser welding is increased as a welding position by laser welding approaches the periphery of the sealing plate from the start point.

4. The method according to claim 1, wherein the case prepared in the preparing the case has a width of 30 cm or more.

5. An electricity storage device obtained by the method according to claim 1, wherein
a welded mark is formed over an entire circumference of the periphery of the sealing plate, and
the welded mark includes an inner projecting portion projecting inward relative to the periphery of the sealing plate.
